(19) United States
(12) Patent Application Publication
(10) Pub. No.: US 2011/0097604 A1
(43) Pub. Date: Apr. 28, 2011

(54) PERPENDICULAR MAGNETIC RECORDING MEDIUM

(75) Inventor: Takahiro Onoue, Singapore (SG)

(73) Assignee: WD MEDIA (SINGAPORE) PTE. LTD., Lake Forest, CA (US)

(21) Appl. No.: 12/935,813

(22) PCT Filed: Mar. 30, 2009
(86) PCT No.: PCT/JP2009/056585

§ 371 Date: Dec. 27, 2010

(30) Foreign Application Priority Data
Mar. 31, 2008 (JP) 2008-093659

(51) Int. Cl. G11B 5/66; G11B 5/65

(52) U.S. Cl. 428/828

(57) ABSTRACT

An object of the present invention is to provide a perpendicular magnetic recording medium capable of reducing noise in an electromagnetic transducing characteristic in a configuration including a magnetic recording layer of a granular structure containing Co and an auxiliary recording layer. The perpendicular magnetic recording medium of the present invention includes: on a non-magnetic substrate, a first magnetic recording layer 20a of a granular structure in which a non-magnetic grain boundary part is provided between magnetic grains in a columnar shape containing at least Co; a non-magnetic layer 22 provided on the first magnetic recording layer 20a; a second magnetic recording layer 20b of a granular structure in which a non-magnetic grain boundary part is provided between magnetic grains in a columnar shape containing Co provided on the non-magnetic layer 22; and an auxiliary recording layer 24 provided on the second magnetic recording layer 20b.

### TECHNICAL FIELD

The present invention relates to a perpendicular magnetic recording medium implemented on an HDD (hard disk drive) of a perpendicular magnetic recording type or the like.

### BACKGROUND ART

With an increase in capacity of information processing in recent years, various information recording technologies have been developed. In particular, the surface recording density of an HDD using magnetic recording technology is continuously increasing at an annual rate of approximately 100%. In recent years, an information recording capacity exceeding 250 GB per one magnetic recording medium with a 2.5-inch diameter for use in an HDD or the like has been desired. To fulfill such demands, an information recording density exceeding 400 Gbits per one square inch is desired to be achieved.

To attain a high recording density in a magnetic disk for use in an HDD or the like, a magnetic recording medium (perpendicular magnetic recording medium) of a perpendicular magnetic recording type has been suggested in recent years. In a conventional in-plane magnetic recording type, the axis of easy magnetization of a magnetic recording layer is oriented in a plane direction of a base surface. In the perpendicular magnetic recording type, by contrast, the axis of easy magnetization is adjusted so as to be oriented in a direction perpendicular to the base surface. In the perpendicular magnetic recording type, compared with the in-plane recording type, a thermal fluctuation phenomenon can be more suppressed at the time of high-density recording, and therefore the perpendicular magnetic recording type is suitable for increasing the recording density.

As a material of a magnetic recording layer suitable for the perpendicular magnetic recording type, CoCrPt—SiO₂ or CoCrPt—TiO₂ has been widely used. These materials have a granular structure in which a crystal of an hcp structure (a hexagonal close-packed crystal lattice) such as Co grows in a columnar shape and Cr and SiO₂ (or TiO₂) are subjected to segregation to form a non-magnetic grain boundary. In this structure, physically independent fine magnetic grains can be easily formed, and a high recording density can be easily attained.

In the above magnetic recording layer, to stably and clearly maintain magnetic bits with fine crystal grains, sufficiently fine grains and small dispersion in particle diameter of the crystal are required. Also, the c axis of Co, that is, an easy axis of magnetization, is required to be perpendicularly oriented with narrow dispersion with a substrate surface.

To obtain the above ideal granular structure, fine structure control is generally performed by using a ground layer. Specifically, on a lower portion of the magnetic recording layer, a single or a plurality of ground layers and, furthermore, a preliminary ground layer (may also be referred to as a seed layer or an orientation control layer) for controlling the structure of the ground layer are multilayered to attain a fine grain structure with excellent orientation.

For example, it has been reported that, by using a NiW film as a preliminary ground layer and laminating a Ru film thereon as a ground layer, it is possible to attain excellent orientation of the c axis, finer crystal grains, and low dispersion in particle diameter (Patent Document 1).

Here, Ru as a material of the ground layer has an hcp structure (a hexagonal close-packed crystal lattice) as Co, and both lattice spacings are close to each other.

Therefore, Ru is used to induce epitaxial growth of Co grains, generate an hcp crystal of Co, and attain excellent orientation of the c axis.

On the other hand, however, due to a difference in crystal lattice spacing between Ru (a=2.705 angstroms) and Co (a=2.503 angstroms), an interface between the Ru film and the magnetic recording layer does not show a complete epitaxial growth, and a lattice defect can be predicted to be induced in the magnetic recording layer. With this, a decrease in crystal magnetic anisotropy (Ku) of the magnetic recording layer may be caused, or an initial degraded layer including a lattice defect may be formed, which may serve as a noise source in electromagnetic transducing characteristic.

### PRIOR ART DOCUMENT

Patent Document 1: Japanese Unexamined Patent Application Publication No. 2007-179598

### DISCLOSURE OF INVENTION

### Problems to be Solved by the Invention

The present invention has been devised in view of the above point, and has an object of providing a perpendicular magnetic recording medium capable of reducing noise in electromagnetic transducing characteristic in a configuration including a magnetic recording layer of a granular structure containing Co and an auxiliary recording layer contributing to an improvement in Hn (inverted-magnetic-domain nucleation magnetic field) and an improvement in overwrite.

### Means for Solving the Problem

A perpendicular magnetic recording medium of the present invention includes, on a non-magnetic substrate, a first magnetic recording layer of a granular structure in which a non-magnetic grain boundary part is provided between magnetic grains in a columnar shape containing at least Co; a non-magnetic layer provided on the first magnetic recording layer; a second magnetic recording layer of a granular structure in which a non-magnetic grain boundary part is provided between magnetic grains in a columnar shape containing Co provided on the non-magnetic layer; and an auxiliary recording layer provided on the second magnetic recording layer.

According to the above configuration, by appropriately adjusting the film thickness of each layer, a strong demagnetizing field is added to the first magnetic recording layer. That is, the magnetic field strength leaking from the first magnetic recording layer is extremely low. With this, noise caused from the first magnetic recording layer can be reduced.

In the perpendicular magnetic recording medium of the present invention, the non-magnetic layer is preferably configured of Ru or a Ru compound.

In the perpendicular magnetic recording medium of the present invention, preferably, the first magnetic recording layer has a thickness equal to or smaller than 5 nm and the non-magnetic layer has a thickness of 0.1 nm to 1 nm.

### Effect of the Invention

The perpendicular magnetic recording medium of the present invention includes, on a non-magnetic substrate, a first magnetic recording layer of a granular structure in which a non-magnetic grain boundary part is provided between magnetic grains in a columnar shape containing Co; a non-magnetic layer provided on the first magnetic recording layer; and a second magnetic recording layer of a granular structure in which a non-magnetic grain boundary part is provided between magnetic grains in a columnar shape containing Co provided on the non-magnetic layer. Therefore, noise in electromagnetic transducing characteristic can be reduced.

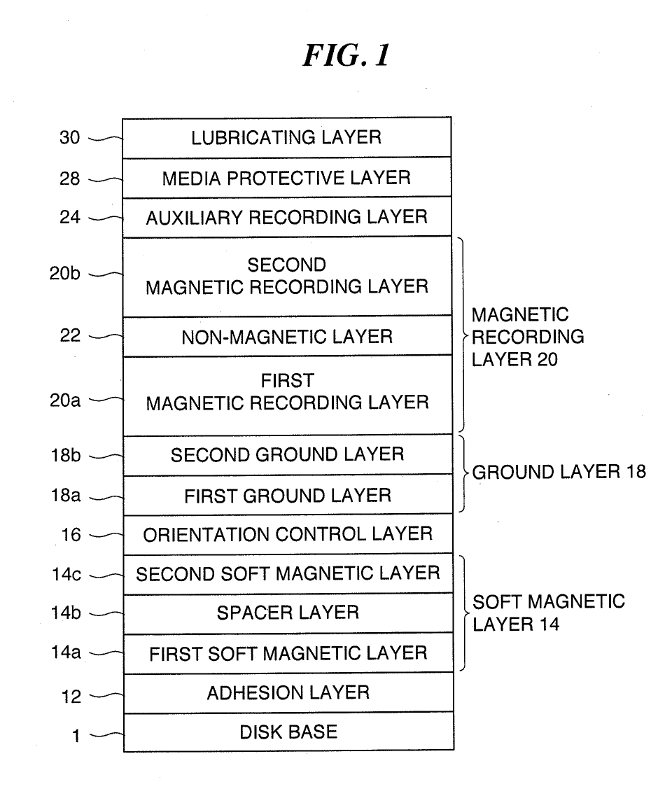

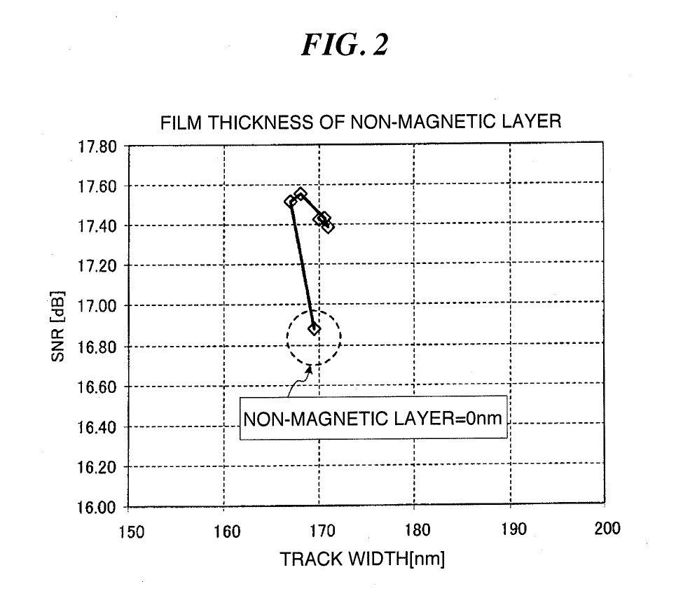

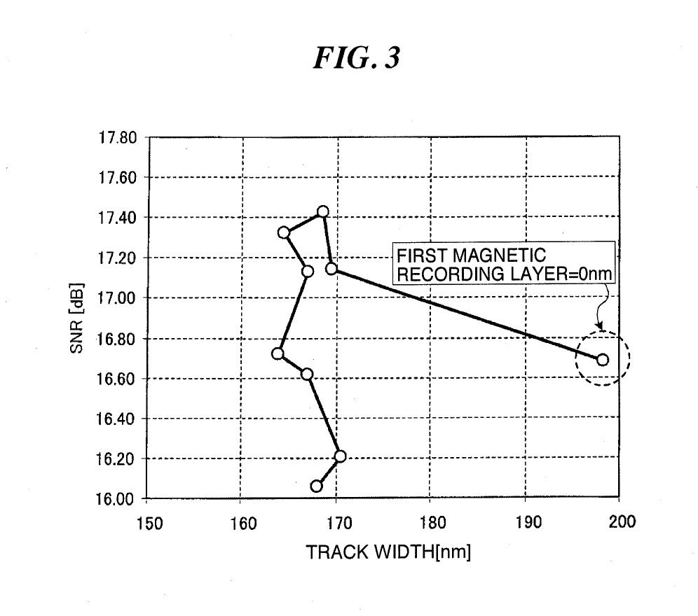

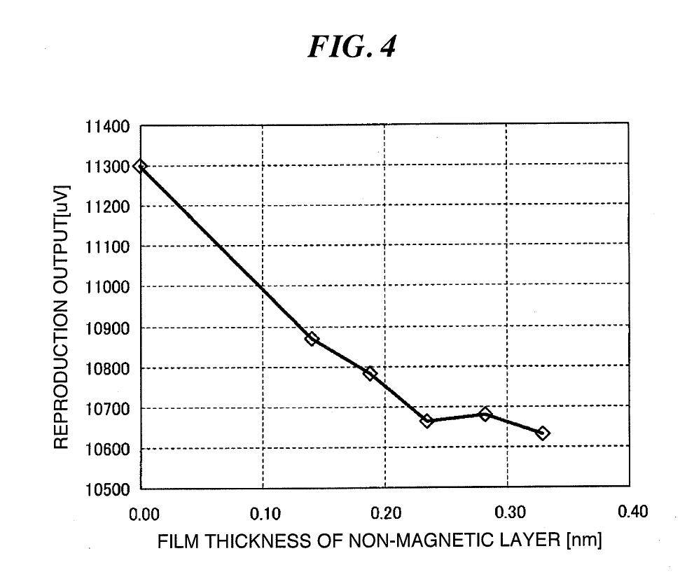

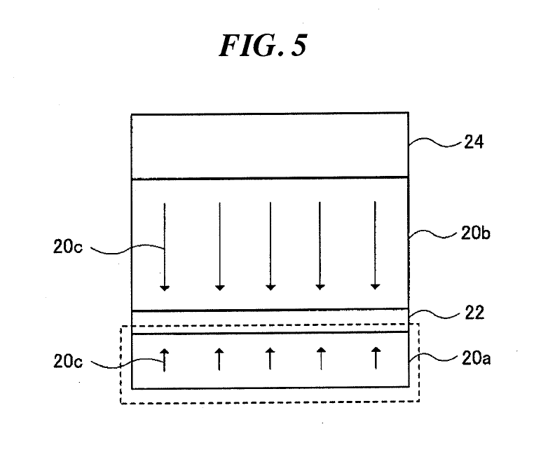

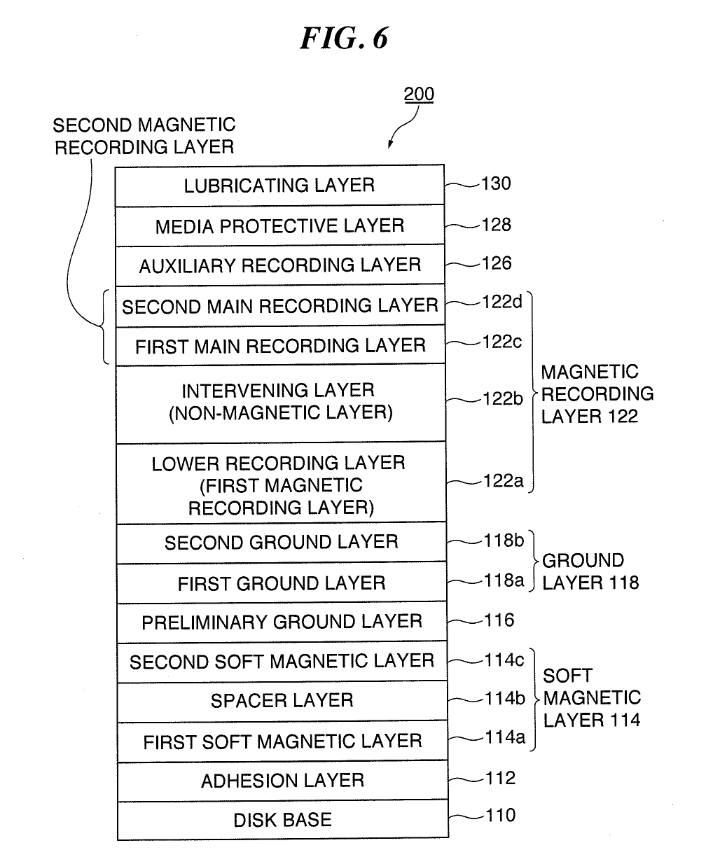

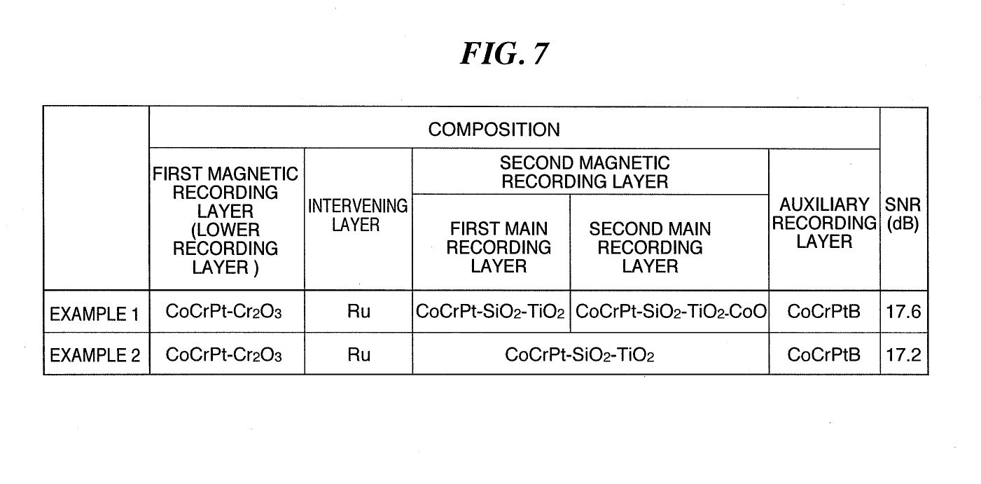

### BRIEF DESCRIPTION OF DRAWINGS

[FIG. 1] A diagram for describing the configuration of a perpendicular magnetic recording medium according to a first embodiment of the present invention.

[FIG. 2] A diagram depicting a relation between an SNR and a track width when the film thickness of a non-magnetic layer is changed.

[FIG. 3] A diagram depicting a relation between an SNR and a track width when the film thickness of a first magnetic recording layer is changed.

[FIG. 4] A diagram depicting a relation between a reproduction output and the film thickness of the non-magnetic layer when the film thickness of the non-magnetic layer is changed.

[FIG. 5] A diagram for describing a magnetic recording layer of the perpendicular magnetic recording medium according to an embodiment of the present invention.

[FIG. 6] A diagram for describing the configuration of a perpendicular magnetic recording medium according to a second embodiment.

[FIG. 7] A diagram for describing SNRs in a perpendicular magnetic recording medium in which a second magnetic recording layer is configured of a plurality of layers.

### DESCRIPTION OF REFERENCE NUMERALS

10 . . . disk base, 12 . . . adhesion layer, 14 . . . soft magnetic layer, 14a . . . first soft magnetic layer, 14b . . . spacer layer, 14c . . . second soft magnetic layer, 16 . . . preliminary ground layer, 18 . . . ground layer, 18a . . . first ground layer, 18b . . . second ground layer, 20 . . . magnetic recording layer, 20a . . . first magnetic recording layer, 20b . . . second magnetic recording layer, 20c . . . orientation of magnetization, 22 . . . non-magnetic layer, 24 . . . auxiliary recording layer, 28 . . . medium protective layer, 30 . . . lubricating layer, 100 . . . perpendicular magnetic recording layer, 110 . . . disk base, 112 . . . adhesion layer, 114 . . . soft magnetic layer, 114a . . . first soft magnetic layer, 114b . . . spacer layer, 114c . . . second soft magnetic layer, 116 . . . preliminary ground layer, 118 . . . ground layer, 118a . . . first ground layer, 118b . . . second ground layer, 122 . . . magnetic recording layer, 122a . . . lower recording layer, 122b . . . intervening layer, 122c . . . first main recording layer, 122d . . . second main recording layer, 126 . . . auxiliary recording layer, 128 . . . medium protective layer, 130 . . . lubricating layer

### BEST MODE FOR CARRYING OUT THE INVENTION

To reduce noise in electromagnetic transducing characteristic based on a difference between crystal lattice spacings between Ru as a material of the ground layer and Co contained in the magnetic recording layer, it can be thought that a layer having a crystal structure and crystal lattice spacing close to those of the magnetic recording layer as much as possible is interposed between the ground layer and the magnetic recording layer to encourage the magnetic recording layer for an ideal epitaxial growth. However, if such a technique is simply taken, Ru of the ground layer and the granular layer of the magnetic recording layer becomes magnetized, and therefore it is clear that the granular layer itself serves as a noise source.

The inventors have noted these points, and found that noise in electromagnetic transducing characteristic can be reduced without posing the above problem by replacing the configuration of a conventional type, ground layer/magnetic recording layer, by a configuration, ground layer/first magnetic recording layer/non-magnetic layer/second magnetic recording layer, thereby devising the present invention.

The gist of the present invention is to reduce noise in electromagnetic transducing characteristic by a perpendicular magnetic recording medium including: on a non-magnetic substrate, a first magnetic recording layer of a granular structure in which a non-magnetic grain boundary part is provided between magnetic grains in a columnar shape containing at least Co; a non-magnetic layer provided on the first magnetic recording layer; a second magnetic recording layer of a granular structure in which a non-magnetic grain boundary part is provided between magnetic grains in a columnar shape containing Co provided on the non-magnetic layer; and an auxiliary recording layer provided on the second magnetic recording layer.

In the following, embodiments of the present invention are described in detail with reference to the attached drawings.

FIG. 1 is a sectional view for depicting a schematic configuration of a magnetic recording medium according to a first embodiment (first embodiment) of the present invention. This magnetic recording medium is a magnetic recording medium for use in a perpendicular magnetic recording type.

### First Embodiment

The magnetic recording medium depicted in FIG. 1 is configured of a disk base 10, an adhesion layer 12, a first soft magnetic layer 14a, a spacer layer 14b, a second soft magnetic layer 14c, a preliminary ground layer 16, a first ground layer 18a, a second ground layer 18b, a first magnetic recording layer 20, a non-magnetic layer 22, a second magnetic recording layer 20b, an auxiliary recording layer 24, a medium protective layer 28, and a lubricating layer 30 multilayered in this order. Note that the first soft magnetic layer 14a, the spacer layer 14b, and the second soft magnetic layer 14c together form a soft magnetic layer 14. The first ground layer 18a and the second ground layer 18b together form a ground layer 18. The first magnetic recording layer 20a, the non-magnetic layer 22, and the second magnetic recording layer 20b together form a magnetic recording layer 20.

As the disk base 10, for example, a glass substrate, an aluminum substrate, a silicon substrate, or a plastic substrate can be used. When a glass substrate is used as the disk base 10, for example, a glass disk is molded in a disk shape by direct-pressing amorphous aluminosilicate glass, and sequentially performing grinding, polishing, and chemical strengthening on this glass disk.

The adhesion layer 12 is a layer for improving adhesiveness with the disk base 10, and can prevent the soft magnetic layer 14 from being peeled off. As the adhesion layer 12, such as a CrTi film can be used.

As the first soft magnetic layer 14a and the second soft magnetic layer 14c, for example, a FeCoTaZr film or the like can be used. As the spacer layer 14b, a Ru film can be used. The first soft magnetic layer 14a and the second soft magnetic layer 14c have an Antiferro-magnetic exchange coupling (AFC). With this, the magnetizing directions of the soft magnetic layer 14 can be arranged along a magnetic path (magnetic circuit) with high accuracy, perpendicular components in the magnetizing direction can be extremely reduced, and noise occurring from the soft magnetic layer 14 can be reduced.

The preliminary ground layer 16 protects the soft magnetic layer 14 and promotes orientation of the crystal particles of the ground layer 18. As a material of the preliminary ground layer 16, one selected from Ni, Cu, Pt, Pd, Zr, Hf, and Nb can be used. Furthermore, an alloy including any of these metals as a main component and any one or more additional elements from among Ti, V, Ta, Cr, Mo, and W may be used. For example, NiW, CuW, or CuCr is suitable.

A material configuring the ground layer 18 has an hcp structure, and the crystals of the hcp structure of the material configuring the magnetic recording layer 20 can be grown so as to have a granular structure. Therefore, as the crystal orientation of the ground layer 18 is higher, the orientation of the magnetic recording layer 20 can be improved. As a material of the ground layer 18, in addition to Ru, a Ru compound, such as RuCr and RuCo, can be used. Ru has an hcp structure, and the magnetic recording layer having Co as a main component can be nicely oriented.

In the present embodiment, the ground layer 18 is configured of a Ru film of a two-layer structure. When the second ground layer 18b on an upper layer side is formed, a gas pressure of R is made higher than that when the first ground layer 18a on a lower layer side is formed. When the gas pressure is increased, a free moving distance of Ru grains to be sputtered is decreased, thereby decreasing a film-formation speed and improving separability of the crystal grains. Also, with a high pressure, the size of crystal lattice is small. Since the size of the crystal lattice of Ru is larger than that of the crystal lattice of Co, if the crystal lattice of Ru is made small, its size becomes closer to that of Co, thereby further improving crystal orientation of the granular layer of Co.

The magnetic recording layer 20 is configured of the first magnetic recording layer 20a (disk base side) and the second magnetic recording layer 20b (auxiliary recording layer side). Each of the first magnetic recording layer 20a and the second magnetic recording layer 20b is a single magnetic layer of a granular structure. As a material of the magnetic recording layers 20a and 20b, CoCrPt—Cr₂O₃, CoCrPt—SiO₂, CoCrPt—TiO₂, and others can be used. In these materials, a plurality of oxides may be included. Here, CoCrPt—Cr₂O₃ was used for the first magnetic recording layer 20a, and CoCrPt—CiO₂.TiO₂ was used for the second magnetic recording layer 20. In these magnetic layers of a granular structure, a non-magnetic substance (oxide) is subjected to segregation around a magnetic substance to form a grain boundary. With this, these magnetic layers have a structure of having a grain boundary part formed of a non-magnetic substance between crystal grains with magnetic particles (magnetic grains) grown in a columnar shape. These magnetic particles are epitaxially grown continuously from the granular structure of the ground layer 18. Note that, as a non-magnetic substance, examples can include silicon oxide (SiOx), chrome (Cr), chrome oxide (CrOx), titanium oxide (TiO₂), zircon oxide (ZrO₂), and tantalum oxide (Ta₂O₅).

To promote an excellent epitaxial growth of the second magnetic recording layer 20b, the first magnetic recording layer 20a is required to be formed as a thin film as long as an excellent crystal structure is kept. For example, the first magnetic recording layer 20a preferably has a thickness equal to or smaller than 5 nm. Also, the second magnetic recording layer 20b preferably has a thickness of 5 nm to 15 nm to obtain a suitable coercive force.

The first magnetic recording layer 20a has an effect of reducing a crystal defect of the second magnetic recording layer 20b and, by extension, reducing medium noise. Therefore, the composition of the first magnetic recording layer 20a is preferably close to the composition of the second magnetic recording layer 20b. Note that, if an appropriate crystal distortion is induced to the second magnetic recording layer 20b, crystal magnetic anisotropy (Ku) is increased and, therefore, in consideration of this point, the composition is preferably adjusted as appropriate.

The non-magnetic layer 22 is provided between the first magnetic recording layer 20a and the second magnetic recording layer 20b. With this, the first magnetic recording layer 20a and the second magnetic recording layer 20b are in a magnetically-separated state and, by selecting an appropriate material and film thickness for the non-magnetic layer, Antiferro-magnetic exchange coupling (AFC) occurs in a film-surface perpendicular direction. That is, the first magnetic recording layer 20a and the second magnetic recording layer 20b are disposed in a direction in which their orientations of magnetization face each other (in antiparallel to each other). With this, a strong demagnetizing field is added to the first magnetic recording layer 20a. That is, the magnetic field strength leaking from the first magnetic recording layer 20a is extremely low. With this, noise caused from the first magnetic recording layer 20a can be reduced. If the film thickness of the first magnetic recording layer 20a is large, the demagnetizing field in the first magnetic recording layer 20a is decreased, and the magnetic field leaking from the first magnetic recording layer 20a is increased to make noise apparent. Also from this point of view, the first magnetic recording layer 20a is preferably thin.

In the present embodiment, the configuration of first magnetic recording layer 20a/non-magnetic layer 22/second magnetic recording layer 20b is described. However, the present invention is not meant to be restricted by this configuration, and the first magnetic recording layer 20a and/or the second magnetic recording layer 20b may be configured of a magnetic recording layer of a plurality of layers. Also, the first magnetic recording layer 20a and/or the second magnetic recording layer 20b may be a layer different in composition in a layer's thickness direction (for example, when the layer is a granular film including an oxide, the amount of content of the oxide varies in a thickness direction).

The non-magnetic layer 22 is preferably made thin so as not to inhibit an epitaxial growth from the first magnetic recording layer 20a to the second magnetic recording layer 20b. For example, the non-magnetic layer 22 preferably has a thickness of 0.1 nm to 1 nm. Also, as a material of the non-magnetic layer 22, in view of not inhibiting an excellent epitaxial growth between that layer and Co, Ru or a Ru compound (RuO, RuCr, RuCo, Ru—SiO₂, Ru—TiO₂, Ru—Cr₂O₃) or the like is desirably used. Note that, when the non-magnetic layer 22 is an extremely thin film, a crystal type not appearing on a phase diagram of the crystal can also be predicted. Therefore, any material can be used on condition that an epitaxial growth of the first magnetic recording layer 20a and the second magnetic recording layer 20b is not inhibited.

In this manner, by multilayering the first magnetic recording layer 20a, the non-magnetic layer 22, and the second magnetic recording layer 20b in this order on the ground layer 18 to form the magnetic recording layer 20, the first magnetic recording layer 20a and the second magnetic recording layer 20b are magnetically separated. Therefore, the film quality of the second magnetic recording layer 20b can be improved and, by extension, noise in electromagnetic transducing characteristic can be reduced (Signal to Noise Ratio (SNR) can be improved). Furthermore, according to this configuration, noise from the first magnetic recording layer 20a does not occur in a magnetostatic sense, thereby achieving low noise in the entire medium.

An object of the auxiliary recording layer 24 is to improve an inverted-magnetic-domain nucleation magnetic field Hn and a heat-resistant fluctuation characteristic, and improve the overwrite characteristic. As the exchange coupling layer 24, for example, a CoCrPt or CoCrPtB film can be used.

On the disk base 10, by using a vacuumed film forming device, the adhesion layer 12 to the auxiliary recording layer 24 are sequentially formed in an Ar atmosphere by DC magnetron sputtering. In consideration of productivity, an in-line-type film formation is preferably used to form these layers and films.

The medium protective layer 28 is a protective layer for protecting the magnetic recording layer from a shock of the magnetic head. As a material configuring the medium protective layer 28, for example, carbon, zirconia, or silica can be used. In general, a carbon film formed by CVD has an improved film hardness compared with the one formed by sputtering, and therefore the perpendicular magnetic recording layer can be more effectively protected from a shock from the magnetic head.

The lubricating layer 30 is formed by, for example, diluting perfluoropolyether (PFPE), which is a liquid lubricant, with a solvent, such as of a Freon type, applying the resultant lubricant on the medium surface by dipping, spin coating, spraying, or others, and performing a heat treatment as required.

Here, the non-magnetic layer in the above-configured perpendicular magnetic recording medium is further described in detail. FIG. 2 is a diagram depicting a relation between an SNR and a track width when the film thickness of the Ru film, which is the non-magnetic layer 22, is changed. Here, the first magnetic recording layer 20a is taken as a CoCrPt—Cr₂O₃ film having a thickness of 2 nm, the second magnetic recording layer 20b is taken as a CoCrPt—.TiO₂.SiO₂ film having a thickness of 10 nm, and the non-magnetic layer 22 has a film thickness changed in a range of 0.2 nm to 1 nm. Also in FIG. 2, as a comparison example, a case in which the non-magnetic layer 22 is not provided is also plotted.

As can be seen from FIG. 2, in the perpendicular magnetic recording medium having the configuration of first magnetic recording layer 20a/non-magnetic layer 22/second magnetic recording layer 20b, that is, the configuration in which the non-magnetic layer 22 is interposed between the first magnetic recording layer 20a and the second magnetic recording layer 20b, the SNR was extremely improved. As a result of diligent studies by the inventors about this phenomenon, a view was obtained in which the reason for this is that the second magnetic recording layer 20b inherits the structure of the first magnetic recording layer 20a to cause Co epitaxially grows in a columnar shape, thereby forming a granular structure with less lattice defects in the second magnetic recording layer 20b. On the other hand, the first magnetic recording layer 20a can be assumed to have a structure with more lattice defects, that is, a structure of inducing high noise in electromagnetic transducing characteristic. However, since the film thickness of the first magnetic recording layer 20a is sufficiently thin and the non-magnetic layer 22 is present, the first magnetic recording layer 20a and the second magnetic recording layer 20b are in a magnetically-separated state. Also, since an appropriate material and film thickness is selected for the non-magnetic layer 22, Antiferro-magnetic exchange coupling (AFC) occurs in a film-surface perpendicular direction. That is, the first magnetic recording layer 20a and the second magnetic recording layer 20b are disposed in a direction in which their orientations of magnetization face each other (in antiparallel to each other). With this, a large demagnetizing field occurs in the first magnetic recording layer 20a. From the first magnetic recording layer 20a, contribution as to either of reproduction output/noise is low, and a view was obtained in which a high SNR was achieved as a whole in the perpendicular magnetic recording medium.

FIG. 3 is a diagram depicting a relation between an SNR and a track width when the film thickness of the CoCrPt—Cr₂O₃ film, which is the first magnetic recording layer 20a, is changed. Here, the non-magnetic layer 22 is taken as a Ru film having a thickness of 0.2 nm, the second magnetic recording layer 20b is taken as CoCrPt—TiO₂.SiO₂ having a thickness of 10 nm, and the first magnetic recording layer 20a has a film thickness changed in a range of 1 nm to 6.5 nm. Also in FIG. 3, as a comparison example, a case in which the first magnetic recording layer 20a is not provided is also plotted.

As can be seen from FIG. 3, it can be found that the track width is significantly improved depending on the presence or absence of the first magnetic recording layer 20a. Also, it can be found that the SNR tends to be decreased when the film thickness of the first magnetic recording layer 20a is equal to or larger than a desired film thickness (5 nm). This result attests to the view in FIG. 2.

FIG. 4 is a diagram depicting a relation between a reproduction output and the film thickness of the non-magnetic layer when the film thickness of the non-magnetic layer is changed. As can be seen from FIG. 4, it was confirmed that an output is decreased by taking the configuration of first magnetic recording layer 20a/non-magnetic layer 22/second magnetic recording layer 20b. A reason for this can be thought such that, with an increase in demagnetizing field added to the first magnetic recording layer 20a, the magnetic field leaking to the outside from the first magnetic recording layer 20a is decreased, thereby not contributing to reproduction output/noise. This result attests to the above assumption.

FIG. 5 is a diagram for describing the magnetic recording layer in the perpendicular magnetic recording medium of the present invention. By taking the configuration of first magnetic recording layer 20a/non-magnetic layer 22/second magnetic recording layer 20b, the first magnetic recording layer 20a and the second magnetic recording layer 20b are in a magnetically-separated state. And, by selecting an appropriate material and film thickness for the non-magnetic layer 22, Antiferro-magnetic exchange coupling (AFC) occurs in a film-surface perpendicular direction. That is, the first magnetic recording layer 20a and the second magnetic recording layer 20b are disposed in a direction in which their orientations of magnetization, 20c, face each other (in antiparallel to each other). For this reason, a strong demagnetizing field occurs in the first magnetic recording layer 20a. From the first magnetic recording layer 20a, contribution as to either of reproduction output/noise is low, and it can be thought that a high SNR was achieved as a whole in the perpendicular magnetic recording medium.

Next, examples performed for clarifying the effect of the present invention are described.

### EXAMPLES

A glass disk was molded in a disk shape by direct-pressing amorphous aluminosilicate glass, and sequentially performing grinding, polishing, and chemical strengthening on this glass disk, thereby fabricating a glass substrate. On this glass substrate, a soft magnetic layer (CoTaZrFe/Ru/CoTaZrFe) having a thickness of 40 nm, a NiW film having a thickness of 10 nm, a Ru film having a thickness of 20 nm, a CoCrPt—Cr₂O₃ film having a thickness of 2 nm, a Ru film having a thickness of 0.2 nm, a CoCrPt—TiO₂.SiO₂ film having a thickness of 10 nm, and an auxiliary recording layer (CoCrPtB) having a thickness of 7 nm were sequentially formed in an Ar atmosphere by DC magnetron sputtering.

Note that, in forming the first magnetic recording layer 20a, a target of a hard magnetic body formed of CoCrPt containing chrome oxide (Cr₂O₃) as an example of a non-magnetic substance was used and, in forming the second magnetic recording layer 20b, a target of a hard magnetic body formed of CoCrPt containing titanium oxide (TiO₂) and silicon oxide (SiO₂) as an example of a non-magnetic substance was used. Also, although different materials (targets) are used between the first magnetic recording layer 20a and the second magnetic recording layer 20b in the present example, this is not meant to be restrictive, and a material of a same composition and type may be used.

Next, a carbon layer having a thickness of 5 nm was formed by CVD on the exchange coupling layer, and a lubricating layer having a thickness of 1.3 nm was formed thereon by dipping, thereby fabricating a perpendicular magnetic recording medium of the example.

For the obtained perpendicular magnetic recording medium, an evaluation regarding electromagnetic transducing characteristic was performed. The evaluation regarding electromagnetic transducing characteristic was performed by examining a recording reproduction characteristic with a magnetic head by using a spin stand. Specifically, an examination was performed by recording a signal by changing a recording density by changing a recording frequency and then reading a reproduction output of this signal. Note that, as a magnetic head, a merge-type head for perpendicular recording with a magnetic-monopole head for perpendicular recording (for recording) and a GMR head (for reproduction) integrated together was used. As a result, the SNR was 17.6 dB. The reason for this can be thought that a strong demagnetizing field is added to the first magnetic recording layer, thereby reducing noise caused from the first magnetic recording layer.

### Comparison Examples

A perpendicular magnetic recording medium of a comparison example was fabricated similarly to the example except that a non-magnetic layer that divides the magnetic recording layer is not provided and that a CoCrPt—Cr₂O₃ film having a thickness of 2 nm is used as a magnetic recording layer. For the obtained perpendicular magnetic recording medium, an evaluation regarding electromagnetic transducing characteristic was performed in a manner similar to that of the example. As a result, the SNR was 16.9 dB. The reason for this can be thought that, due to the absence of a non-magnetic layer, noise caused from the magnetic recording layer was not able to be reduced.

The present invention is not meant to be restricted to the above example, and can be modified as appropriate for implementation. For example, the structure of the magnetic recording layer and the auxiliary recording layer is not particularly restrictive, but preferably, the magnetic recording layer is at least one magnetic layer having a granular structure. As the auxiliary recording layer, a layer having a granular structure, a continuous film, a so-called cap layer with a lower degree of isolation of grains than that of the granular layer, or an amorphous layer without having a crystal structure can be used. Also, the layer configuration, the material, number, and size of each member, the process procedure, and others in the above embodiment are merely by way of example, and can be variously changed for implementation. In addition, various changes can be made for implementation as long as they do not deviate from a range of purposes of the present invention.

### Second Embodiment

Next, a second embodiment of the present invention is described. In the first embodiment, the second magnetic recording layer is configured of one layer. By contrast, in the second embodiment, the second magnetic recording layer is configured of two layers, a first main recording layer and a second main recording layer. Note that the layer provided between the first magnetic recording layer and the second magnetic recording layer is referred to as a non-magnetic layer in the first embodiment, such a non-magnetic layer is referred to as an intervening layer in the second embodiment.

FIG. 6 is a diagram for describing the configuration of a perpendicular magnetic recording medium 100 according to the second embodiment. The perpendicular magnetic recording medium 100 depicted in FIG. 6 is configured of a disk base 110, an adhesion layer 112, a first soft magnetic layer 114a, a spacer layer 114b, a second soft magnetic layer 114c, a preliminary ground layer 116, a first ground layer 118a, a second ground layer 118b, a lower recording layer (first magnetic recording layer) 122a, an intervening layer (non-magnetic layer) 122b, a first main recording layer 122c, a second main recording layer 122d, an auxiliary recording layer 126, a medium protective layer 128, and a lubricating layer 130. Note that the first soft magnetic layer 114a, the spacer layer 114b, and the second soft magnetic layer 114c together form a soft magnetic layer 114. The first ground layer 118a and the second ground layer 118b together form a ground layer 118. The first main recording layer 122c and the second main recording layer 122d together form a second magnetic recording layer. The lower recording layer 122a (first magnetic recording layer) 122a and the intervening layer 112b, and a first main recording layer 122c and a second main recording layer 122d (second magnetic recording layer) together form the magnetic recording layer 122.

For the disk base 110, a glass disk molded in a disk shape by direct-pressing amorphous aluminosilicate glass can be used. Note that the type, size, thickness, and others of the glass disk are not particularly restricted. A material of the glass disk can be, for example, aluminosilicate glass, soda lime glass, soda alumino silicate glass, aluminoborosilicate glass, borosilicate glass, quartz glass, chain silicate glass, or glass ceramic, such as crystallized glass. This glass disk is sequentially subjected to grinding, polishing, and chemical strengthening, thereby allowing the smooth, non-magnetic disk base 110 made of chemically-strengthened glass disk to be obtained.

On the disk base 110, the adhesion layer 112 to the auxiliary recoding layer 126 are sequentially formed by DC magnetron sputtering, and the medium protective layer 128 can be formed by CVD. Then, the lubricating layer 130 can be formed by dip coating. Note that, in view of high productivity, using an in-line-type film forming method is also preferable. In the following, the configuration of each layer and its manufacturing method are described.

The adhesion layer 112 is formed in contact with the disk base 110, and includes a function of increasing a peel strength between the soft magnetic layer 114 formed thereon and the disk base 110 and a function of making crystal grains of each layer formed on the soft magnetic layer 114 fine and uniform. When the disk base 110 is made of amorphous glass, the adhesion layer 112 is preferably an amorphous (amorphous) alloy film so as to comply with that amorphous glass surface.

As the adhesion layer 112, for example, any can be selected from a CrTi-type amorphous layer, a CoW-type amorphous layer, a CrW-type amorphous layer, a CrTa-type amorphous layer, and a CrNb-type amorphous layer. The adhesion layer 112 may be a single layer formed of a single material, but may be formed by multilayering a plurality of layers. For example, a CoW layer or a CrW layer may be formed on a CrTi layer. Also, preferably, these adhesion layers 112 are subjected to sputtering with a material containing carbon dioxide, carbon monoxide, nitrogen, or oxygen, or have their surface layer exposed in any of these gases.

The soft magnetic layer 114 is a layer in which a magnetic path is temporarily formed at the time of recording so as to let a magnetic flux pass through the magnetic recording layer 122 in a perpendicular direction in a perpendicular magnetic recording type. By interposing the non-magnetic spacer layer 114b between the first soft magnetic layer 114a and the second soft magnetic layer 114c, the soft magnetic layer 114 can be configured to include Antiferro-magnetic exchange coupling (AFC). With this, magnetizing directions of the soft magnetic layer 114 can be aligned with high accuracy along the magnetic path (magnetic circuit), the number of perpendicular components in the magnetizing direction becomes extremely small, and therefore noise occurring from the soft magnetic layer 114 can be reduced. As the composition of the first soft magnetic layer 114a and the second soft magnetic layer 114c, a cobalt-type alloy, such as CoTaZr; a Co—Fe-type alloy, such as CoCrFeB and CoFeTaZr; a Ni—Fe-type alloy having a [Ni—Fe/Sn]n multilayered structure or the like can be used.

The preliminary ground layer 116 is a non-magnetic alloy layer, and includes an operation of protecting the soft magnetic layer 114 and a function of orienting in a disk perpendicular direction an easy axis of magnetization of a hexagonal close-packed structure (hcp structure) included in the ground layer 118 formed on the preliminary ground layer. In the preliminary ground layer 116, a (111) surface of a face-centered cubic structure (fcc structure) is preferably parallel to a main surface of the disk base 110. Also, the preliminary ground layer 116 may have a configuration in which these crystal structures and amorphous are mixed. As a material of the preliminary ground layer 116, a selection can be made from Ni, Cu, Pt, Pd, Zr, Hf, Nb, and Ta. Furthermore, an alloy including any of these metals as a main component and any one or more additional elements from among Ti, V, Cr, Mo, and W may be used. For example, NiW, CuW, or CuCr can be suitably selected as an alloy taking a fcc structure.

The ground layer 118 has an hcp structure, and has an operation of growing crystals of the hcp structure of Co of the magnetic recording layer 122 as a granular structure. Therefore, as the crystal orientation of the ground layer 118 is higher, that is, a (0001) surface of a crystal of the ground layer 118 is more parallel to the main surface of the disk base 110, the orientation of the magnetic recording layer 122 can be improved. As a material of the ground layer 118, Ru is typical. Other than that, a selection can be made from RuCr and RuCo. Ru has an hcp structure, and an atomic space of the crystal is close to that of Co. Therefore, the magnetic recording layer 122 having Co as a main component can be oriented in good condition.

When the ground layer 118 is made of Ru, by changing the gas pressure at the time of sputtering, a two-layer structure made of Ru can be achieved. Specifically, when the first ground layer 118a on a lower-layer side is formed, the gas pressure of Ar is set at a predetermined pressure, that is, a low pressure and, when the second ground layer 118b on an upper-layer side is formed, the gas pressure of Ar is set higher than that when the first ground layer 118a on a lower-layer side is formed, that is, at a high pressure. With a high pressure, the crystal orientation of the magnetic recording layer 122 can be improved with the first ground layer 118a, and the particle diameter of the magnetic grains of the magnetic recording layer 122 can be made finer with the second ground layer 118b.

Furthermore, when the gas pressure is made higher, an average free path of plasma ions to be sputtered is shortened, thereby decreasing the film-forming speed becomes slow and making a coat rough. Therefore, separation of the crystal grains of Ru and making them finer can be promoted, and the crystal grains of Co can also made finer.

Furthermore, minute quantities of oxygen may be contained in Ru of the ground layer 118. With this, separation of the crystal grains of Ru and making them finer can be further promoted, and further isolation of the magnetic recording layer 122 and making them finer can be achieved. Therefore, in the present embodiment, in the ground layer 118 configured of two layers, the second ground layer formed immediately blow the magnetic recording layer contains oxygen. That is, the second ground layer is configured of RuO. With this, the above advantage can be most effectively obtained. Note that, although oxygen may be contained by reactive sputtering, when a film is formed by sputtering, a target containing oxygen is preferably used.

The magnetic recording layer 122 has a granular structure in a columnar shape in which a non-magnetic grain boundary part is formed by segregation of a non-magnetic substance around magnetic grains of a hard magnetic body formed of a Co-type alloy. In the present embodiment, the magnetic recording layer 122 is configured of the lower recording layer 122a, which is a first magnetic recording layer; the intervening layer 122b, which is a non-magnetic layer; and the first main recording layer 122c and the second main recording layer 122d, which forms a second magnetic recording layer. With this, small crystal grains of the first main recording layer 122c and the second main recording layer 122d grow continuously from the crystal grains (magnetic grains) of the lower recording layer 122a, thereby making the main recording layer finer and improving the SNR. Note that, other than the above Co-type alloy, a Fe-type alloy or a Ni-type alloy can be suitable used for the magnetic recording layer 122.

In the present embodiment, CoCrPt—Cr₂O₃ is used for the lower recording layer 122a. In CoCrPt—Cr₂O₃, segregation of Cr₂O₃ (oxide), which is a non-magnetic substance, is around the magnetic magnetic grains (grains) formed of CoCrPt to form a grain boundary, thereby forming a granular structure in which magnetic grains grows in a columnar shape.

The intervening layer 122b is a non-magnetic thin film. With this layer interposed between the lower recording layer 122a and the first main recording layer 122c, magnetic continuity among them is divided. Here, with the film thickness of the intervening layer 122b being set at a predetermined film thickness (0.7 to 0.9 nm), Antiferro-magnetic exchange coupling (AFC) occurs between the lower recording layer 122a and the first main recording layer 122c. With this, between the layers above and below the intervening layer 122b, magnetization is drawn to each other to mutually operate so that the magnetizing direction is fixed, thereby reducing fluctuations of the axis of magnetization and reducing noise.

The intervening layer 122b is preferably configured of Ru or a Ru compound. This is because, since the atomic space of Ru is close to that of Co configuring the magnetic grains, an epitaxial growth of the crystal grains of Co is less prone to being inhibited even when Ru is interposed between the magnetic recording layers 122. Also, an epitaxial growth is less prone to being inhibited because the intervening layer 122b is extremely thin.

In particular, in the present embodiment, the intervening layer 122b is assumed to be a layer made of Ru formed at a gas pressure lower than a gas pressure at the time of forming the ground layer 118. With this, the intervening layer 122b can be as a coat with a density higher than that of the ground layer 118. Therefore, even if metal is deposited from a layer formed below the intervening layer 122b, it is possible to prevent such metal from reaching the surface of the perpendicular magnetic medium 100, thereby preventing the occurrence of corrosion.

Here, the lower recording layer 122a would have been a magnet continued with the second magnetic recoding layer (the first main recording layer 122c and the second main recording layer 122d), but becomes a separate short magnet because it is divided by the intervening layer 122b. And, by making the film thickness of the lower recording layer 122a thinner, an aspect ratio of the granular magnetic particles becomes shorter (in the perpendicular magnetic recording medium 100, the film thickness direction refers to a vertical direction of an easy axis of magnetization), and therefore the demagnetizing field occurring inside of the magnet becomes strong. For this reason, although the lower recording layer 122a is hard magnetic, a magnetic moment for output to the outside is small, thereby tending not to be easily picked up by the magnetic head. That is, by adjusting the film thickness of the lower recording layer 122a, the magnetic fluxes are difficult to reach the magnetic head. Also, for the first main recording layer 122c, magnetization (strength of the magnet) is set at a degree of having a magnetic interaction, thereby achieving a magnetic recording layer with less noise while achieving a high coercive force.

In the present embodiment, the second magnetic recording layer is configured of the first main recording layer 122c provided above the intervening layer 122b (disk base 110 side) and the second main recording layer 122d above the first main recording layer 122c (main surface side of the perpendicular magnetic recording medium 100).

For the first main recording layer 122c, CoCrPt—SiO₂—TiO₂ is used. With this, also in the first main recording layer 122c, segregation of SiO₂ and TiO₂ (composite oxide), which are non-magnetic substances, is caused around the magnetic grains (grains) made of CoCrPt to form a grain boundary, thereby forming a granular structure with the magnetic gains grown in a columnar shape.

Also, in the present embodiment, the second main recording layer 122d continues with the first main recording layer 122c, but is different in composition and thickness from therefrom. For the second main recording layer 122d, CoCrPt—SiO₂—TiO₂—CoO is used. With this, also in the second main recording layer 122d, segregation of SiO₂, TiO₂, and CoO (composite oxide), which are non-magnetic substances, is caused around the magnetic grains (grains) made of CoCrPt to form a grain boundary, thereby forming a granular structure with the magnetic gains grown in a columnar shape.

As described above, in the present embodiment, the configuration is such that CoO (oxide of Co) is contained in the second main recording layer 122d and more oxides are included in the second main recording layer 122d than the first main recording layer 122c. With this, from the first main recording layer 122c to the second main recording layer 122d, separation of the crystal grains can be promoted stepwise

Also, as described above, with an Co oxide being contained in the second main recording layer 122d, a decrease in crystallinity and crystal orientation of the magnetic grains due to oxygen deficiency can be prevented. In detail, it is a fact that oxygen deficiency occurs when an oxide, such as SiO₂ or TiO₂, is mixed into the magnetic recording layer 122. Si ions or Ti ions are mixed into the magnetic grains to distort crystal orientation and decrease the coercive force Hc. To get around this, with a Co oxide being contained, it is possible to cause the Co oxide to function as a oxygen carrier for complementing this oxygen deficiency. An example of the Co oxide is CoO, but may be Co₃O₄.

A Co oxide has a Gibbs free energy ΔG larger than that of SiO₂ and TiO₂, and Co ions and oxygen ions are prone to being separated. Therefore, oxygen is separated preferentially from the Co oxide to complement oxygen deficiency occurring in SiO₂ and TiO₂, thereby completing ions of Si and Ti as oxides for deposition to the grain boundary. With this, it is possible to prevent foreign substances, such as Si and Ti, from being mixed into the magnetic grains and also prevent crystallinity of the magnetic grains from being disturbed by this mixing. Here, although it can be thought that superfluous Co ions are mixed into the magnetic grains, the magnetic grains are made of a Co alloy, to begin with, and thus the magnetic characteristic is not impaired. Therefore, crystallinity and crystal orientation of the magnetic grains are improved, thereby increasing the coercive force Hc. Also, since saturation magnetization Ms is improved, an overwrite characteristic is advantageously improved.

However, there is a problem in which the SNR is decreased when a Co oxide is mixed into the magnetic recording layer 122. To get around this, as described above, the first main recording layer 122c not having a Co oxide mixed into is provided. With this, while a high SNR is ensured with the first main recording layer 122c, a high coercive force Hc and overwrite characteristic can be obtained with the second main recording layer 122d. Note that the film thickness of the second main recording layer 122d is preferably thicker than the film thickness of the first main recording layer 122c and, as a suitable example, the thickness of the first main recording layer 122c can be set at 2 nm and the thickness of the second main recording layer 122d can be set at 8 nm.

Note that the substances used for the lower recording layer 122a and the first main recording layer 122c and the second main recording layer 122d described above are merely by way of example, and are not meant to be restrictive. Examples of the non-magnetic substance for forming a grain boundary can include silicon oxide (SiOₓ), chrome (Cr), chrome oxide (CrₓO_{y}), titanium oxide (TiO₂), zircon oxide (ZrO₂), tantalum oxide (Ta₂O₅), iron oxide (Fe₂O₃), and boron oxide (B₂O₃). Also, a nitride, such as BN, or a carbide, such as B₄C₃, can be suitably used.

Furthermore, in the present embodiment, one type of non-magnetic substance (oxide) is used in the lower recording layer 122a, two types thereof are used in the first main recording layer 122c, and three types thereof are used in the second main recording layer 122d. However, this is not meant to be restrictive. For example, in any one or all of the lower recording layer 122a to the second main recording layer 122d, one type of non-magnetic substance may be used, and two or more types of non-magnetic substance can also be used in combination. Here, although the type of non-magnetic substance to be contained is not restricted, as in the present embodiment, in particular, SiO₂ and TiO₂ are preferably contained. Therefore, unlike the present embodiment, when the lower recording layer 122a to the second main recording layer 122d are each configured of only one layer (when the intervening layer 122b is not provided), such magnetic recording layers are preferably each made of CoCrPt—SiO₂—TiO₂.

The auxiliary recording layer 126 is a magnetic layer approximately continuing magnetically in an in-plane direction on the main surface of the disk base. The auxiliary recording layer 126 is required to be adjacent or in proximity to the magnetic recording layer 122 so as to have a magnetic interaction therewith. Examples of the auxiliary recording layer 126 can include CoCrPt, CoCrPtB, or substances configured by making minute quantities of oxygen contained therein. The auxiliary recording layer 126 has an object of adjusting the inverted-magnetic-domain nucleation magnetic field Hn and the coercive force Hc, thereby improving the heat-resistant fluctuation characteristic, the OW characteristic, and the SNR. To achieve this object, the auxiliary recording layer 126 preferably has excellent perpendicular magnetic anisotropy Ku and saturation magnetization Ms. Note that that the auxiliary recording layer 126 is provided on an upper portion of the magnetic recording layer 122 in the present embodiment, but may be provided on a lower portion thereof.

Note that “magnetically continuing” means that magnetism is continuous and “approximately magnetically continuing” means that the target is not one magnet when the auxiliary recording layer 126 is observed as a whole and magnetism may be discontinuous due to the grain boundary of the crystal grains. In the grain boundary, not only the crystal is discontinuous but also Cr may be subjected to segregation. Furthermore, minute quantities of oxide may be contained for segregation. However, even when the grain boundary containing an oxide is formed in the auxiliary recording layer 126, it is preferably smaller in area than the grain boundary of the magnetic recording layer 122 (the amount of content of the oxide is small). Although the functions and operations of the auxiliary recording layer 126 are not necessarily clear, it is thought that, by having a magnetic interaction with the granular magnetic grains of the magnetic recording layer 122 (by making an exchange coupling), the auxiliary recording layer 126 can adjust Hn and Hc to improve the heat-resistant fluctuation characteristic and the SNR. Also, the crystal grains connected to the granular magnetic grains (crystal grains having a magnetic interaction) each have a wider area than the cross-section of the granular magnetic grain, the crystal grains receive many magnetic fluxes from the magnetic head and become prone to flux reversal, thereby improving an overall OW characteristic.

The medium protective layer 128 can be formed by CVD out of carbon, with a vacuum state being kept. The medium protective layer 128 is a layer for protecting the perpendicular magnetic recording medium 100 from a shock of the magnetic head. In general, a carbon film formed by CVD has an improved film hardness compared with the one formed by sputtering, and therefore the perpendicular magnetic recording medium 100 can be more effectively protected from a shock from the magnetic head.

The lubricating layer 130 can be formed by dip coating with PFPE (perfluoropolyether). PFPE has a long-chain molecular structure, and is bound to an N atom on the medium protective layer 128 with a high affinity. With this operation of the lubricating layer 130, a damage and loss of the medium protective layer 128 can be prevented even if the magnetic head makes contact with the surface of the perpendicular magnetic recording medium 100.

With the above manufacturing process, the perpendicular magnetic recording medium 100 was able to be obtained. Next, examples of the second embodiment are described.

### EXAMPLES

On the disk base 110, by using a vacuumed film forming device, the adhesion layer 112 to the auxiliary recording layer 126 were sequentially formed in an Ar atmosphere by DC magnetron sputtering. The adhesion layer 112 was of CrTi. In the soft magnetic layer 114, the composition of the first soft magnetic layer 114a and the second soft magnetic layer 114c was of CoFeTaZr, and the composition of the spacer layer 114 was of Ru. The composition of the preliminary ground layer 116 was of NiW. As the first ground layer 118a, a Ru film was formed in an Ar atmosphere at a predetermined pressure (low pressure: for example, 0.6 to 0.7 Pa). As the second ground layer 118b, a Ru (RuO) film containing oxygen was formed by using a target including oxygen in an Ar atmosphere at a pressure (high pressure: for example, 4.5 to 7 Pa) higher than a predetermined pressure. In the lower recording layer 122a, Cr₂O₃ was contained in the grain boundary part as an example of oxide to form an hcp crystal structure of CoCrPt—Cr₂O₃. The intervening layer 122b was formed of Ru formed at a gas pressure lower than that at the time of forming the ground layer 118. In the first main recording layer 122c, SiO₂ and TiO₂ were contained in the grain boundary part as examples of composite oxide (oxides of a plurality of types) to form an hcp crystal structure of CoCrPt—SiO₂—TiO₂. In the second main recording layer 122d, SiO₂, TiO₂, and CoO were contained in the grain boundary part as examples of composite oxide (oxides of a plurality of types) to form an hcp crystal structure of CoCrPt—SiO₂—TiO₂—CoO. The composition of the auxiliary recording layer 126 was of CoCrPtB. As for the medium protective layer 128, a film was formed by using C₂H₄ and CN by CVD, and the lubricating layer 130 was formed by using PFPE by dip coating.

FIG. 7 is a diagram for describing SNRs in the perpendicular magnetic recording medium 100 in which the second magnetic recording layer is configured of a plurality of layers. In FIG. 7, a first example is a perpendicular magnetic recording medium configured of two second magnetic recording layers, as described above. A second example has a configuration similar to that of the first example except for the second magnetic recording layer, the second magnetic recording layer is a perpendicular magnetic recording medium configured of one layer as with the first embodiment, and this medium is to be compared with the first example.

With reference to FIG. 7, it was found that, in the first example, a SNR higher than that of the second example can be ensured. From this, it can be understood that, by configuring the second magnetic recording layer with two layers, the first main recording layer and the second main recording layer, and making CoO (Co oxide) contained in the second main recording layer, it is possible to increase the SNR of the perpendicular magnetic recording medium and contribute to the attainment of further increasing the recording density.

In the foregoing, with reference to the attached drawings, preferred examples of the present invention have been described. However, needless to say, the present invention is not meant to be restricted by such examples. It is obvious that a person skilled in the art can conceive various modification examples and corrected examples within a category described in the scope of claims for patent. As a matter of course, it is understood that these also belong to the technical scope of the present invention.

### INDUSTRIAL APPLICABILITY

The present invention can be utilized as a perpendicular magnetic recording medium mounted on an HDD (hard disk drive) or the like of perpendicular magnetic recording type.

1. A perpendicular magnetic recording medium comprising:
on a non-magnetic substrate,
a first magnetic recording layer of a granular structure in which a non-magnetic grain boundary part is provided between magnetic grains in a columnar shape containing at least Co;
a non-magnetic layer provided on the first magnetic recording layer;
a second magnetic recording layer of a granular structure in which a non-magnetic grain boundary part is provided between magnetic grains in a columnar shape containing Co provided on the non-magnetic layer; and
an auxiliary recording layer provided on the second magnetic recording layer.

2. The perpendicular magnetic recording medium according to claim 1, wherein the non-magnetic layer is configured of Ru or a Ru compound.

3. The perpendicular magnetic recording medium according to claim 1, wherein
the first magnetic recording layer has a thickness equal to or smaller than 5 nm, and the non-magnetic layer has a thickness of 0.1 nm to 1 nm.

4. The perpendicular magnetic recording medium according to claim 1, wherein
the second magnetic recording layer is configured of a first main recording layer provided on the non-magnetic layer and a second main recording layer provided on the first main recording layer, and
the second main recording layer contains at least an oxide of Co as an oxide configuring the grain boundary part.

5. The perpendicular magnetic recording medium according to claim 1, wherein
the perpendicular magnetic recording medium further includes a ground layer formed of Ru or a Ru compound below the first magnetic recording layer, and
the non-magnetic layer provided on the first magnetic recording layer is a layer of Ru formed with a gas pressure lower than a gas pressure at the time of forming the ground layer.

6. The perpendicular magnetic recording medium according to claim 2, wherein
the first magnetic recording layer has a thickness equal to or smaller than 5 nm, and the non-magnetic layer has a thickness of 0.1 nm to 1 nm.
